(19) United States
(12) Patent Application Publication
(10) Pub. No.: US 2023/0184948 A1
(43) Pub. Date: Jun. 15, 2023

(54) Laser Tracking Module

(71) Applicant: Julian Christopher Boice, Woodland Hills, CA (US)

(72) Inventor: Julian Christopher Boice, Woodland Hills, CA (US)

(21) Appl. No.: 17/548,730

(22) Filed: Dec. 13, 2021

(51) Int. Cl. G01S 17/66; G01S 7/481

(52) U.S. Cl. CPC G01S 17/66; G01S 7/4814

(57) ABSTRACT

A tracking system includes a stand with a plurality of movable aiming arms, each coupled to a laser unit, where all units are connected to a single power supply; and multiple laser units to create a plurality of marks on a green screen.

### BACKGROUND

Tracking markers are typically on set to help aid VFX artists with motion tracking and rotoscoping. For scenes with no stark contrast between objects and the background, or scenes with a blurry or glossy surface, tracking markers are needed to track how the camera is moving in relation to the background. Traditionally this is done by placing tape in “X” “L” or “T”. A large green screen can have hundreds of these tracking markers. Because of poor accuracy the process is complex, the time taken to identify each and every marker and edit the video can be significantly longer and cumbersome which drive up the costs.

### SUMMARY

A tracking system having a stand with a plurality of movable aiming arms, each with a laser unit, where all units are connected to a single power supply; multiple laser unit to create a lasting mark on a green screen; portable tripod to support, stabilize and elevate the system, have three legs and a mechanism to be able to rotate and tilt a mounting the movable aiming arms mounted on the tripod; a mount clamp to fasten the movable aiming arms to tripod; a stabilizer to hold the laser units in a manner that prevents or compensates for unwanted movement, such as “laser shake”; a heat sink to absorb and regulate heat generated by power supply; power supply to provide power; movable aiming arms are mounted on the tripod and attached with multiple laser unit.

Advantages of the system may include one or more of the following. The system can carry more laser unit with movable arms making it more accurate and able to place multiple markers on an object for extended amounts of time. This arrangement allows the laser beam to create precise, high quality, high-contrast marks that are easy to read or scan on virtually any surface. This feature makes laser marking ideal for video production on a green screen, where accuracy and permanency are desirable. In this case, tracking laser module can be placed or moved around the green screen marking the positional cues, in which the beams targets only a specified area, allowing the laser marking machine to create precise, high quality, high-contrast marks that are easy to read or scan on virtually any surface. In comparison to manual tracking markers such as dark green crosses, the lighting is even, making it easier to key in during editing and thus saves editing time.

### BRIEF DESCRIPTION

Turning now descriptively to the drawings, in which similar reference characters denote similar elements throughout the several views, the figures illustrate the electronic book of the present invention. With regard to the reference numerals used, the following numbering is used throughout the various drawing figures.

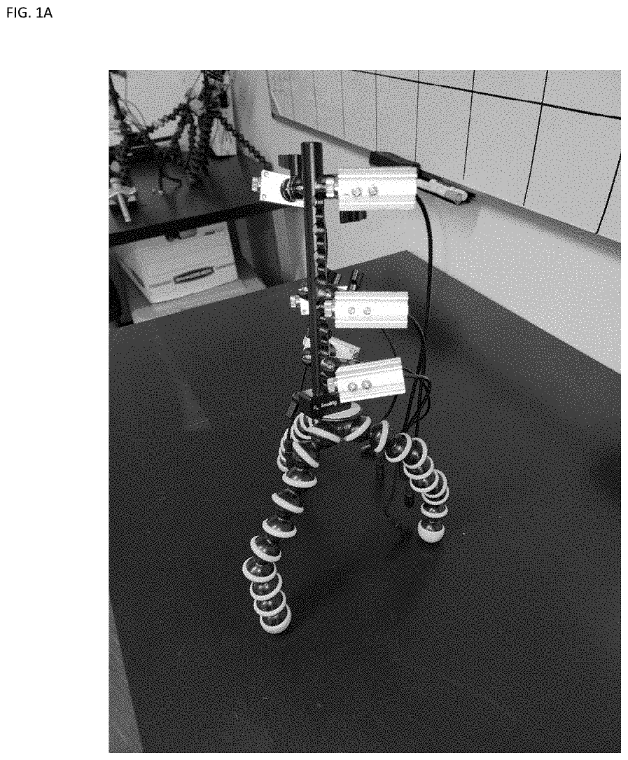

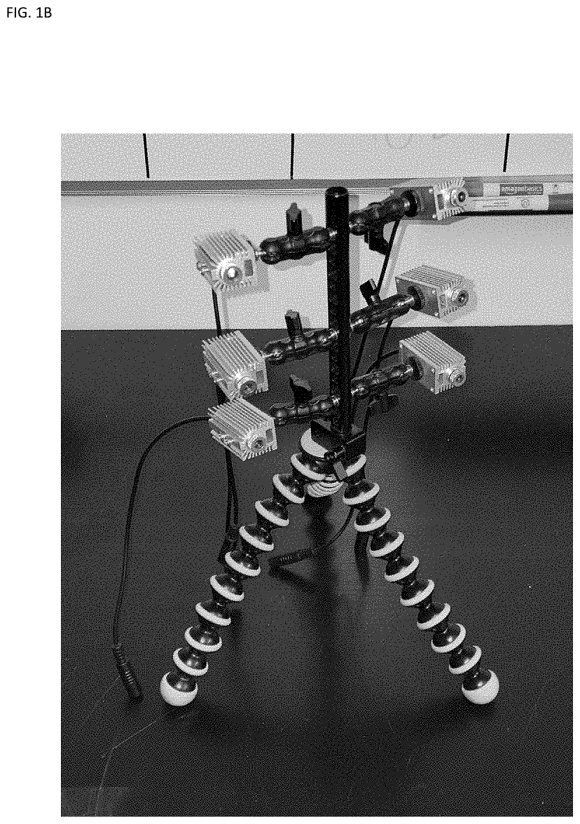

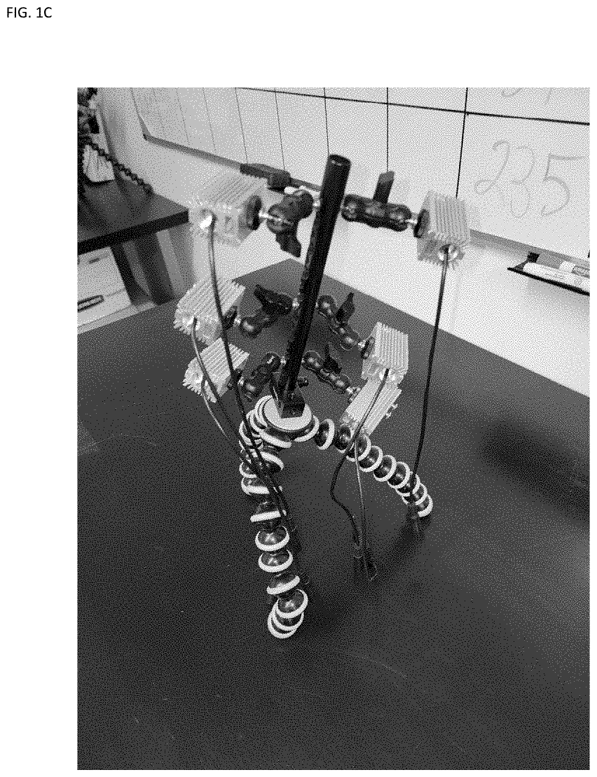

FIGS. 1A-1B show an exemplary multiple-laser tracking system to generate markers for VFR movie recording.

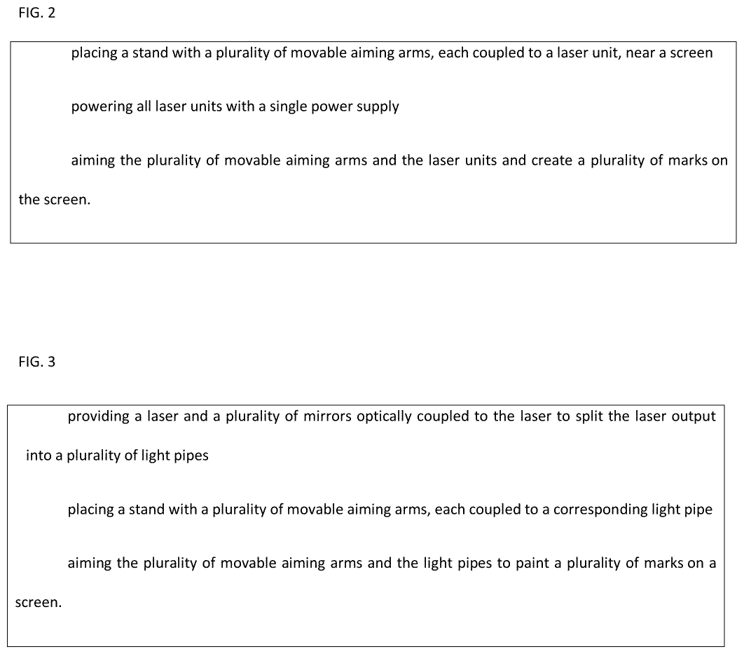

FIGS. 2-3 show exemplary processes for using one or more lasers to generate markers for VFR movie recording.

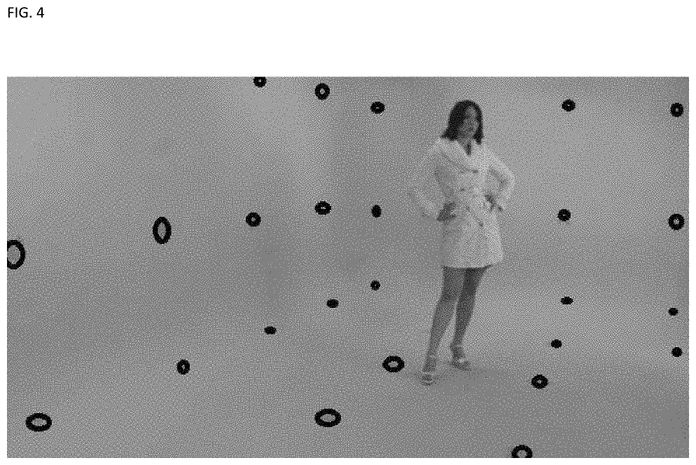

FIG. 4 shows an exemplary green screen with laser markings.

### DETAILED DESCRIPTION

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

FIGS. 1A-1C show an exemplary multiple-laser tracking system to generate markers for VFX movie recording. The tracking system has a stand with a plurality of movable aiming arms, each with a laser unit, where all units are connected to a single power supply. This allows the laser beam to be created on location. As a result, the present system also provides the opportunity to create the shot with far less labor intensive work required from additional personnel using a plurality of lasers increase accuracy by allowing many markers to be generated, each with a single beam to be tracked on a single spot on the green screen. Using multiple lasers will allow more surface area to be covered on the green screen creating better contrast with the final video. A portable tripod to support, stabilize and elevate the system, have three legs and a mechanism to be able to rotate and tilt a mounting the movable aiming arms mounted on the tripod. In other uses, a tripod's articulating legs can be used to clamp onto items to mount the module. The laser modules can be placed high on stands or clamped to walls or ceilings to have a good area to project the lasers from.

The use of a plurality of lasers placed on a separate movable aiming arms creates multiple distinct marks that are able to be used for editing instead of using one marker at a time which requires more editing time to Track. With more precision on the laser placement on the green screen and these distinct marks on specific parts of the object or actor being recorded, allows the operator of the machine to not have to aim so accurately. This new arrangement of the laser aiming arm is able to use less accurate pointing of the laser unit while still being able to get enough laser power onto the mark. Ona traditional set up the laser beam is placed manually on the surface of the green screen then on key frame can move around to get different position pose of the camera, then on another key frame the laser unit would be moved back to the original place. This arrangement allows the laser beam to of laser marking machine to create precise, high quality, high-contrast marks that are easy to read or scan on virtually any surface.

It is quick and easy to install. Because it is small, it takes up little space when not in use. This innovative design allows for movable aiming arms to move up, down, left, right, tilt forward, tilt backward, rotate clockwise, rotate counterclockwise, or any combination of these movements. The range of motion is nearly unlimited. This mechanism also allows the movable aiming arms to turn, which can rotate 360 degrees around its vertical axis. These movement are all controlled by a ball joint system that rotates on the stand. The bottom of the stand is equipped with an elevation foot to make adjustments possible. The tripod has three adjustable legs. Each leg can adjust up or down separately or be completely extended at the same time. An elevation pin is used to lock each leg into place. The legs can be adjusted while the tripod is still upright. This mounting device is an ideal platform for mounting the Laser Marking Machine onto the tripod. The plate was created so that all other components can connect directly to it without having to worry about mounting hardware. On the top side of the plate, there are threaded holes where other equipment can attach directly to it, such as motors, motors controller, power supply, laser units, etc. There are six ¼-_20 tapped holes that are used to attach the aiming arms to the mounting plate.

To attach the arms to the tripod, there is a mount clamp that connects on the base of the arm and slides onto the leg of the tripod. This mount clamp as a groove which allows for friction on the bottom of the mount clamp to fit onto the top of the tripod leg. For example, there are three legs on the tripod, the groove of the clamp fits onto the outer portion of the first and third leg, which can slide up and down as needed. The second leg has a screw-hole so the clamp can be tightened around it. Thus, this clamp allows for movement along three axis: front and back, left and right, and up and down. This will help stabilize the arm and hold it in place. This is used to create a mounting platform for the entire system. A heat sink to absorb and regulate heat generated by power supply Excerpt from DRAWINGS detailing one preferred method of constructing the mechanism supporting multiple laser units on the movable aiming arms, which are connected to the same power supply unit. Other methods are also described.

The lasers are mounted on the movable aiming arms, which can be rotated and tilted. The rotation and tilt of the movable aiming arms creates different positions for lasers. Each of the laser beams is directed through a lens (which may be plastic or glass) onto the intended surface. The glass lens has an AR coating to minimize distortion. When one or more laser beams are directed at the intended surface, the reflected light returns to the lens creating small bright dots on the surface. As the lens directs the nature of these dots it will change due to distance, size, shape, orientation, reflectivity and refractive index. This dot pattern may also include dots of focus, called speckle noise, due to interference between the multiple laser events. The arrangement of the laser spots, their color, shape, size, orientation, reflectivity and speckle noise pattern depends on the positioning of the lenses. Any laser color can be used, such as red, blue, green, among others. Also, the laser outputs can be of arbitrary shape as detailed herein. The resultant beam combination produces one or more tracking dot patterns in the target area. There are two common techniques for marking moving objects with tracking markers. They are automatic or manual. Manual markers are made by simply placing dark crosses in the scene, where the camera position is identified using 3 point set up. These manual markers are not easy to place accurately. It takes several seconds to several minutes to place the crosses manually. In another embodiment, one laser is needed, and the output is piped to a series of mirrors to split the laser beam and the outputs of the mirrors are then used to project multiple dots off of one laser module.

A heat sink is a passive electronic component that absorbs and dissipates energy from other components to regulate the temperature of the components to a set point. When a semiconductor chip or a circuit board is operating at a high-power output, it produces a lot of heat which can affect its ability to function correctly. A heat sink allows the laser chip or board to run at high temperatures without damaging itself. The purpose of a heat sink is to remove heat by absorbing and dissipating heat away from the chip. Heat sinks are designed to dissipate heat in all directions, allowing for equal cooling across the device, thus creating a fast and cost-effective process in creating the movie production.

Tracking system comprises a stand with a plurality of movable aiming arms, each with a laser unit, where all units are connected to a single power supply. Each movable aiming arm is attached to a laser unit.

The system of FIGS. 1A-1C provide the following features:
Must be able to lock down and hold the lasers steady for hours.
Lasers need to be operational for hours (avoiding overheating/burnout problems)
Lasers need to be focusable in case they're placed right next to the wall they're aiming at or 200 ft away.
Must be easily adjustable on the fly. (Also including the ease of one power source)
Must have multiple lasers. Some situations require the use of over 100 lasers.

In one embodiment, the system includes the following:

| Item# | Item | Number |
|---|---|---|
| 001 | Lasers | 6 |
| 002 | Power Supply | 1 |
| 003 | SMALLRIG 15 mm Rod Clamp | 1 |
| 004 | SmallRig 15 mm Cheese Rod | 1 |
| | SmallRig Universal Magic Arm | |
| | with Small Ballhead (4pcs) | |
| 005 | 2159 | 6 |
| 006 | JOBY Gorillapod 3K Stand | 1 |
| 007 | Heat Sync | 6 |

FIG. 4 shows an exemplary screen with laser markings. The system creates dots on the green screen and the user can adjust the dot size to be as small as possible. They should be just big enough to be seen by camera. These “dots” would be circles, but square or other shapes can be rendered by each laser beam. While not preferred, the laser beam can be adjusted to create shapes that are Xs, Ls, Ts or plus signs, or checkerboard patterns, or triangles, etc. If desired, the laser color can be white dots on a dark background. For dots on a green or blue screen, the laser can create bright squares of the same color. The system can create nine dots on screen at any point to get a good track/match-move. The dots can leave and re-enter frame during camera moves, creating more dots off camera that come on when the camera is panned and tilted.

The system can render many tracking markers fast, for example on a green or blue screen. Blue lasers are great for blue screen. Likewise, green lasers for green screen. The markers should be just bright enough to be visible to avoid spending time doing roto or paint to clean up the edges.

FIGS. 2-3 show exemplary processes for using one or more lasers to generate markers for VFR movie recording. In one embodiment, a power supply powers the lasers and a processor and sensors. The processor receives user commands on laser output level for each level and also shape of target spots on the screens. The processor in turn controls apertures and/or beam output to the appropriate color, intensity, and beam shape on the screen.

In FIG. 2, the process uses multiple lasers and includes the following:
placing a stand with a plurality of movable aiming arms, each coupled to a laser unit, near a screen
powering all laser units with a single power supply
aiming the plurality of movable aiming arms and the laser units and create a plurality of marks on the screen.

In FIG. 3 the process uses one laser with multiple beam splitters or mirrors and includes the following:
providing a laser and a plurality of mirrors optically coupled to the laser to split the laser output into a plurality of light pipes
placing a stand with a plurality of movable aiming arms, each coupled to a corresponding light pipe
aiming the plurality of movable aiming arms and the light pipes to paint a plurality of marks on a screen.

In one example, the system can be operated as follows:
Users film the shot.
Users use the green screen to help Rotoscope the image (or remove the part of the image users don't want)
Users use tracking markers (what the lasers provide) to track the movement of the shot so anything users add in later properly tracks to the live action elements in the shot. This means that if the camera does not move during the shot (or a locked off camera), there is no need for tracking markers (there's no movement to track).
Users add in an element, or whatever is missing in the shot (aka a new background, or a new/missing section of the set, or a separately captured element).
That element is tracked to the movement of the shot (using the tracking achieved from the tracking markers).

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim.

1. A tracking system comprising:
a stand with a plurality of movable aiming arms, each coupled to a laser unit, where all units are connected to a single power supply; and
multiple laser units to create a plurality of marks on a green screen.

2. The system of claim 1, wherein the stand is set up to support, stabilize and elevate the laser units.

3. The system of claim 1, wherein the stand comprises three legs and a mechanism to rotate and tilt a mounting the movable aiming arms.

4. The system of claim 1, comprising a mount clamp to fasten the movable aiming arms to a tripod.

5. The system of claim 1, comprising a stabilizer to hold the laser units in a manner that prevents or compensates for unwanted movement.

6. The system of claim 1, comprising a heat sink to absorb and regulate heat generated by laser units.

7. The system of claim 6, wherein the heat sink comprises a plurality of fins.

8. The system of claim 1, wherein each movable aiming arm have six-degrees of freedom in aiming the laser unit.

9. The system of claim 1, wherein the laser unit renders an adjustable dot size.

10. The system of claim 1, wherein the laser unit renders an X pattern, an L pattern, a T pattern, a plus pattern, a checkerboard pattern, or a triangle pattern.

11. A method for VFX tracking, comprising:
placing a stand with a plurality of movable aiming arms, each coupled to a laser unit, near a screen,
powering all laser units with a single power supply;
aiming the plurality of movable aiming arms and the laser units and create a plurality of marks on the screen.

12. The method of claim 11, comprising setting the stand to support, stabilize and elevate the laser units.

13. The method of claim 11, wherein the stand comprises three legs and a mechanism to rotate and tilt a mounting the movable aiming arms.

14. The method of claim 11, comprising clamping or fastens the movable aiming arms to a tripod.

15. The method of claim 11, comprising stabilizing the laser units to prevent or compensate for unwanted movement.

16. The method of claim 11, comprising absorbing heat generated by the laser units.

17. The system of claim 16, comprising providing a plurality of fins to dissipate heat.

18. The method of claim 11, wherein each movable aiming arm have six-degrees of freedom in aiming the laser unit.

19. The method of claim 11, comprising rendering the marker with an adjustable dot size, an X pattern, an L pattern, a T pattern, a plus pattern, a checkerboard pattern, or a triangle pattern.

20. A method for VFR tracking, comprising:
providing a laser and a plurality of mirrors or beam splitters optically coupled to the laser to split the laser output into a plurality of light pipes;
placing a stand with a plurality of movable aiming arms, each coupled to a corresponding light pipe; and
aiming the plurality of movable aiming arms and the light pipes to paint a plurality of marks on a screen.
